(19) United States
(12) Patent Application Publication
(10) Pub. No.: US 2008/0043015 A1
(43) Pub. Date: Feb. 21, 2008

(54) ONLINE VOLUME RENDERING SYSTEM AND METHOD

(76) Inventors: Michael Valdiserri, Tucson, AZ (US); Warren J. Goble, Tucson, AZ (US)

Correspondence Address: ROBERT A. PARSONS, 4000 N. CENTRAL AVENUE, SUITE 1220, PHOENIX, AZ, 85012, US

(21) Appl. No.: 11/840,084

(22) Filed: Aug. 16, 2007

Related U.S. Application Data
(60) Provisional application No. 60/838,120, filed on Aug. 16, 2006.

(51) Int. Cl. G06T 15/00

(52) U.S. Cl. 345/419

(57) ABSTRACT

A volumetric rendering system including a user electronic interface device having data storage for storing volumetric scan data, a server device including a volume rendering software program and having data storage for receiving the volumetric scan data from the user electronic device, and a network coupling the user electronic device to the server device. A volume rendering engine is coupled to the server device for creating a volume rendered image from the volumetric scan data. A video streaming engine is coupled to the volume rendering engine for receiving and encoding the volume rendered image as a video. The video streaming engine includes a video streaming protocol for streaming the video to the user electronic interface real-time.

### CROSS-REFERENCE TO RELATED APPLICATIONS

This application claims the benefit of U.S. Provisional Application No. 60/838,120, filed 16 Aug. 2006.

### FIELD OF THE INVENTION

This invention relates to volume rendering.

More particularly, the present invention relates to online volume rendering.

### BACKGROUND OF THE INVENTION

The field of art of the present invention is the generation of rendered volumes from data files or sets. A typical 3D data set is a group of 2D slice images acquired by a volumetric scanning device such as CAT scanners, PET scanners, CT scanners, MRI scanners and the like. The scan data is typically developed to form a volumetric grid, with each volume element, or voxel represented by a single value that is obtained by sampling the immediate area surrounding the voxel. To render a 2D projection of the 3D data set, a perspective point is defined releative to the volume. Opacity and color of every voxel is typically defined using an RGBA (for red, green, blue, alpha) transfer function that defines the RGBA value for every possible voxel value.

A volume is viewed by extracting surfaces of equal values from the volume and rendering them as polygonal meshes or by rendering the volume directly as a block of data. The Marching Cubes algorithm is a common technique for extracting a surface from volume data. Direct volume rendering is can be performed in several ways. A computer containing an executable program for rendering a volume image employs the data sets to generate the image as directed by the operator. Volume rendering is a computationally intensive task requiring a relatively powerful computer to generate images which can then be manipulated. The need for powerful computational devices and special software greatly reduces the availability of volume rendering. The cost of obtaining and maintaining a powerful computer as well as the cost of specialized software keeps volume rendering out of the reach of many who could benefit from the technology.

It would be highly advantageous, therefore, to remedy the foregoing and other deficiencies inherent in the prior art.

Accordingly, it is an object of the present invention to provide a new and improved method and system for volume rendering.

It is an object of the present invention to provide volume rendering capability online, without the need for high powered computer or executable programs on site.

### SUMMARY OF THE INVENTION

Briefly, to achieve the desired objects of the present invention in accordance with a preferred embodiment thereof, provided is a volume rendering system. The volumetric rendering system includes a user electronic interface device having data storage for storing volumetric scan data, a server device including a volume rendering software program and having data storage for receiving the volumetric scan data from the user electronic device, and a network coupling the user electronic device to the server device. A volume rendering engine is coupled to the server device for creating a volume rendered image from the volumetric scan data. A video streaming engine is coupled to the volume rendering engine for receiving and encoding the volume rendered image as a video. The video streaming engine includes a video streaming protocol for streaming the video to the user electronic interface real-time.

Also provided is a method of generating volume rendered images. The method includes the steps of providing a user interface device having user data storage coupled to a server device having server data storage by a network. Volumetric scan data is obtained and stored in the user data storage of the user interface device. The server device is accessed from the user interface device and the volumetric scan data is sent to the server data storage through the network. An image is rendered from the volumetric scan data and encoded into a video. The video is streamed over the network to the user interface device.

### BRIEF DESCRIPTION OF THE DRAWING

Specific objects and advantages of the invention will become readily apparent to those skilled in the art from the following detailed description of a preferred embodiment thereof, taken in conjunction with the drawing in which:

FIG. 1 is a simplified block diagram of the online volume rendering system.

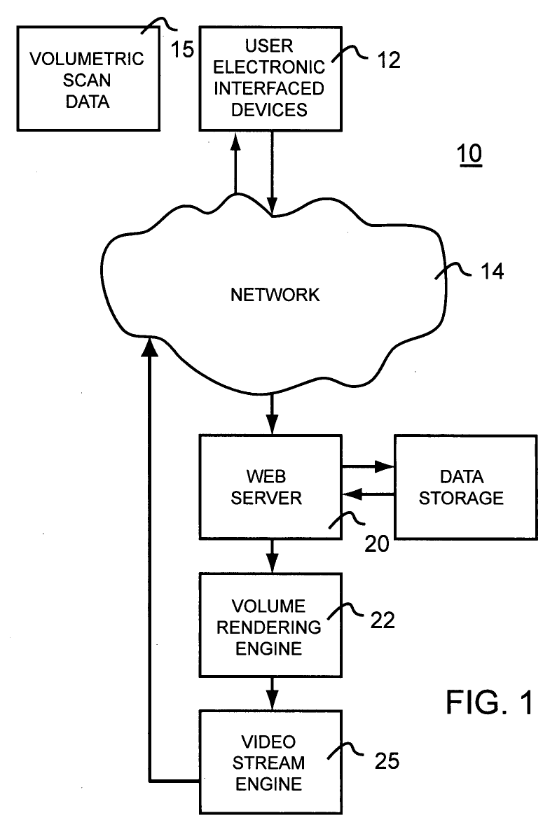

### DETAILED DESCRIPTION OF A PREFERRED EMBODIMENT

Turning now to the drawing, a simplified block diagram of an online volume rendering system generally designated 10 is illustrated. System 10 includes a user electronic interface device 12 having data storage. It will be understood that in the term data storage is intended to include internal or external memory devices as well as removable memory storage such as CDs, flash drives and the like. Device 12 is an electronic computing device such as a computer or computerized instrument (MRI, PET, CT scan, and the like) or device such as a laptop, PDA, cell phone, etc. Device 12 can be substantially any device having data input features which permits an input of data, and which has access to remote systems such as networks and, particularly, the Internet or World Wide Web 14, whether over landlines or wireless. Device 12 carries and can run an access software application such as a web browser to access network 14. Data input into device 12 can include control data, as will be described presently, and volumetric scan data to be rendered into a 3-dimensional volume rendering.

The first step in the process is obtaining volumetric scan data 15. Volumetric scan data can be obtained by using volumetric scanning devices such as CAT scans, PET scans, CT scans, MRI scans, Ultrasound scans, Laser 3D scanners, and the like. The data generated by volumetric scanning devices can come in a variety of forms, but is typically provided in the form of a specified standard called DICOM (digital imaging and communications in medicine). This scan data is provided by the user to device 12 and transferred to a server device 20 via network 14. Many scan devices have associated computing devices which can perform this function and therefore act as device 12, or the scan data can first be collected by a volumetric scan device and then stored by device 12 in the data storage. In the latter case, device 12 is a stand alone device such as a computer.

Server device 20 receives commands and data from device 12 and, in turn, controls the rendering process. Server 20 downloads the scan data from device 12 via network 14. The downloaded scan data is then volume rendered by volume rendering engine 22 to create a volume rendered image. The volume rendered image is then converted into streaming video and transferred back to user device 12 via network 14. In this manner, no specialized imaging software, large computing power, or specialized video cards are required by the user device.

Volume rendering engine 22 is the specialized volume rendering software program or programs and any other manipulations needed to generate a 3-D rendered image from the volumetric scan data. Volume rendering engine 22 is considered to be coupled to server device 20, whether it is simply a rendering program carried by and run on the server, whether a plurality of servers each having rendering program carried thereby or and run thereon. A single computing device can act as server device 20 and volume rendering engine 22 when the rendering software is loaded on the server device 20. While a single computing device can be employed as server device 20 and volume rendering engine 22 to render the data, multiple computing devices can also be employed. For example, a stack of server devices can be employed, each having the rendering software. Another embodiment employs a plurality of computing devices which will be referred to as a cluster of rendering boxes. Each rendering box is essentially a specialized graphics computer having a single or a plurality of parallel graphic cards. The parallelization of the graphics cards in one box greatly increases the speed and efficiency of a volume rendering process which will be referred to as a job. The provision of a cluster or server stack, allows the rendering engine to be scalable, meaning rendering boxes can be added to the cluster to improve on performance or to accommodate increased levels of users without degrading performance. Providing a rendering engine in the form of a rendering cluster allows a large number of rendering jobs to be performed simultaneously. Multiple users and/or multiple rendering jobs are distributed through the multiple rendering boxes in the rendering cluster, allowing parallel rendering operations. When a user logs in, or otherwise enters the rendering system, that user's rendering job is assigned to a rendering box with enough free resources to perform the rendering operation in the least amount of time. Various techniques or software can be employed in the rendering process, such as Ray-casting, MIP (Maximum Intensity Projection), Iso-Surface, Image segmentation, or the like. The control of the rendering process, such as running the specialized rendering software, and determining the rendering box to use, is provided by the server device.

Once a volume rendered image has been generated, the image is sent to a video streaming engine 25 where it is converted into a video format (H. 263, H. 264, MPEG 4, V6 etc.) acceptable to video streaming software such as Windows Media Player, Quicktime, or Flash. This video is then streamed over the network to the user device. In the preferred embodiment, the video streaming engine can include a cluster of video streaming boxes to allow multiple video feeds to be processed or the video stream engine can run as a process on the volume rendering boxes of the rendering engine. After a volume rendered image is created by the rendering engine, the volume rendered image is passed on to the video streaming engine where it is assigned to a video box to compress the image and send the rendered image to the user within the web browser. If using a cluster of video streaming boxes, when a new user logs in, a video streaming box is selected based upon enough free resources to render the images real-time. As an example, if there are three video streaming boxes in the video engine and there are three users, all three video boxes will be processing a different job. If there are four users all three video boxes plus the video box with the lowest load will process the jobs.

The video streaming engine uses a process which encodes raw video from the volume rendering process. The video streaming engine then sends the video back to the end user interface real-time using a standard video streaming protocol. The video streaming engine runs as a background task, to which the rendering process sends uncompressed frames which get stored in a buffer. Once a frame gets stored into a buffer, the streaming server encodes the video frame and sends it to the client's web browser.

To facilitate providing images desired by the user, user device 12 includes a web browser or other user interface that requests a control interface from server device 20 when a volume rendering session is to begin. Server device 20 then processes user control and feedback and relays commands to the rendering engine. The control interface includes various control options as desired, such as, upload DICOM data, rotate, pan, zoom, slice, highlight, color, etc. A dynamic interface between device 12 and server device 20 through network 14 allows a constant update of volume rendered images as directed by the user on the user control interface. The commands from the user interface device to the server device over the network direct the volume rendering engine to update the rendered image sent to the video streaming engine which then send the video stream to the user. In this manner, as the DICOM data is processed and rendered, the 3-dimensional rendered image generated can be rotated, enlarged, etc., to provide a view angle, or the like, desired by the user. Once a desired image or video is completed, this data can then be downloaded to the user device as a finished file.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. A volume rendering system comprising:
a user electronic interface device having data storage for storing volumetric scan data;
a server device having data storage for receiving the volumetric scan data from the user electronic device;
a network coupling the user electronic device to the server device;
a volume rendering engine coupled to the server device for creating a volume rendered image from the volumetric scan data;
a video streaming engine coupled to the volume rendering engine for receiving and encoding the volume rendered image as a streaming video; and
the video streaming engine includes a video streaming protocol for streaming the video to the user electronic interface real-time.

2. A volume rendering system as claimed in claim 1 wherein the volume rendering engine is coupled to the server by being carried by and run thereon.

3. A volume rendering system as claimed in claim 1 wherein the volume rendering engine includes a cluster of rendering boxes, each rendering box being a specialized graphics computer.

4. A volume rendering system as claimed in claim 3 wherein each rendering box includes a plurality of parallel graphic cards.

5. A volume rendering system as claimed in claim 1 wherein the video streaming engine includes a cluster of video streaming boxes.

6. A volume rendering system as claimed in claim 1 wherein the video streaming engine is a process on the volume rendering boxes of the volume rendering engine.

7. A volume rendering system as claimed in claim 2 wherein the server device includes a control interface accessed by the access software application of the user interface device when a volume rendering session is to begin for processing user control, feedback and relays commands to the rendering engine.

8. A method of generating volume rendered images comprising the steps of:
providing a user interface device having user data storage coupled to a server device having server data storage by a network;
obtaining volumetric scan data;
storing the volumetric scan data in the user data storage of the user interface device
accessing the server device from the user interface device and sending the volumetric scan data to the server data storage through the network;
rendering an image from the volumetric scan data;
encoding the image into a streaming video; and
streaming the video over the network to the user interface device.

9. A method as claimed in claim 8 wherein the step of rendering an image from the volumetric scan data includes providing a volume rendering engine controlled by the server device.

10. A method as claimed in claim 9 where in the step of providing a volume rendering engine includes providing a cluster of rendering boxes, each rendering box being a specialized graphics computer.

11. A method as claimed in claim 10 where in the step of providing a volume rendering engine further includes providing each rendering box with a plurality of parallel graphic cards.

12. A method as claimed in claim 8 where in the steps of encoding and streaming includes providing a video streaming engine.

13. A method as claimed in claim 12 wherein the step of providing a video streaming engine includes providing a cluster of video streaming boxes.

14. A method as claimed in claim 10 where in the steps of encoding and streaming are a process on the volume rendering boxes of the volume rendering engine.

15. A method as claimed in claim 8 further including the step of processing user control feedback and relays commands to the rendering engine by accessing a control interface of the server device using an access software application of the user interface device when a volume rendering session is to begin.

16. A method as claimed in claim 15 wherein the user control feedback includes at least one of upload volumetric scan data, rotate image, pan image, zoom, slice, highlight, color.
